(19) United States
(12) Patent Application Publication
(10) Pub. No.: US 2013/0097028 A1
(43) Pub. Date: Apr. 18, 2013

(54) Dynamic Floor Pricing for Managing Exchange Monetization

(71) Applicants: PENG HAN, Issaquah, WA (US); STEVEN J. HANKS, Seattle, WA (US); ERIK J. HANSON, Woodinville, WA (US); ROBERT PAUL GORMAN, Woodinville, WA (US); XIAOBIN DONG, Sammamish, WA (US); QING XU, San Jose, CA (US)

(72) Inventors: PENG HAN, Issaquah, WA (US); STEVEN J. HANKS, Seattle, WA (US); ERIK J. HANSON, Woodinville, WA (US); ROBERT PAUL GORMAN, Woodinville, WA (US); XIAOBIN DONG, Sammamish, WA (US); QING XU, San Jose, CA (US)

(73) Assignee: MICROSOFT CORPORATION, Redmond, WA (US)

(21) Appl. No.: 13/273,542

(22) Filed: Oct. 14, 2011

(51) Int. Cl. G06Q 30/02

(52) U.S. Cl. 705/14.71

(57) ABSTRACT

Systems and method are provided for conducting an auction to match an advertising payload to an available advertising impression. In the auction, a dynamic floor price is provided. The dynamic floor price provides a way for a publisher to incorporate the internal value of the available impression into the auction process, while still allowing the publisher to maximize the value of the available impression by exposing the impression to bids from outside parties. The dynamic floor price can be calculated based on both internal valuations of an available impression as well as external valuations derived from feedback from prior auctions. To facilitate determination of a dynamic floor prices, advertisers and available impressions can be categorized into various segments.

### CROSS REFERENCE TO RELATED APPLICATIONS

This application is related to pending U.S. application Ser. No. 13/116,949, filed on May 26, 2011, titled Unified Yield Management for Display Advertising, the entirety of which is incorporated herein by reference.

### BACKGROUND

Online advertising can be an important piece of the marketing campaigns and sales strategies of many client businesses, advertisers, or content providers. In order to accommodate advertisers wishing to post online advertisements, web pages are often designed to offer content regions therein for sale. These content regions can be configured to present advertisements to the end user upon navigating to the web pages. A delivery engine can be responsible for accepting orders for placement of advertising impressions and distributing the advertisements for presentation at the content regions of selected web pages.

One type of advertising campaign order that can be received is an order for a guarantee of delivery of a number of impressions. This can sometimes be referred to as a reserved advertising campaign. A reserved campaign order can be guaranteed upon acceptance of the order. That is, the delivery engine can make a commitment to show the number of impressions as instructed in the order. For instance, if an advertiser places an order for one million impressions of a particular advisement, acceptance of the order by a delivery engine corresponds to an agreement that the delivery engine will cause each of the one million impressions to occur. If the delivery engine does not meet its obligation to present each of the one million impressions of the advertisement, or underdelivers, the advertisers may experience customer dissatisfaction which may result in the delivery engine losing business or being forced to offer rebates to retain their current business. This problem of fulfilling the orders accepted by the delivery engine can be exaggerated in the situation where the delivery engine is servicing a multitude of advertisers that each place various orders with different time frames for presenting impressions of the advertisements being ordered.

Conventional mechanisms for ascertaining how to deliver ordered impressions of advertisements and for determining whether inventory is available for accepting new orders can be labor-intensive (e.g., requiring a considerable amount of user-initiated tracking and calculations) and are not fluid, flexible, or efficient. Further, these conventional mechanisms are ad-hoc solutions that cannot dynamically react to a change in orders or inventory.

Although reserved campaigns can be purchased, a portion of the available impressions may be available after the requirements of all reserved campaigns are satisfied. This remnant of additional impressions can be fulfilled by selling the additional impressions in a non-guaranteed fashion, such as on an as-needed basis. This additional as-needed advertising can supplement the income of the owner of the available impressions.

### SUMMARY

In various embodiments, systems and method are provided for conducting an auction to match an advertising payload to an available advertising impression. In the auction, a dynamic floor price is provided. The dynamic floor price provides a way for a publisher to incorporate the internal value of the available impression into the auction process, while still allowing the publisher to maximize the value of the available impression by exposing the impression to bids from outside parties. The dynamic floor price can be calculated based on both internal valuations of an available impression as well as external valuations derived from feedback from prior auctions. To facilitate determination of dynamic floor prices, advertisers and available impressions can be categorized into various segments.

This Summary is provided to introduce a selection of concepts in a simplified form that are further described below in the Detailed Description. This Summary is not intended to identify key features or essential features of the claimed subject matter, nor is it intended to be used as an aid, in isolation, in determining the scope of the claimed subject matter.

### BRIEF DESCRIPTION OF THE DRAWINGS

The invention is described in detail below with reference to the attached drawing figures, wherein:

FIGS. 1a-1c schematically shows an example of an auction process according to an embodiment of the invention.

FIG. 2 is a block diagram of an exemplary computing environment suitable for use in implementing embodiments of the present invention.

FIG. 3 schematically shows a system environment suitable for performing embodiments of the invention.

FIG. 4-6 show examples of methods according to various embodiments of the invention.

### DETAILED DESCRIPTION

### Overview

In various embodiments, systems and methods are provided for allowing competition for advertising impressions between reserved (or guaranteed) advertising campaigns and non-reserved campaigns. By allowing reserved and non-reserved campaigns to compete, the revenue generated by impressions can be enhanced or optimized while still satisfying the guarantees required by the guaranteed campaign. In such a competition, systems and methods are provided for dynamic setting of floor prices for acceptance of a bid from a non-reserved campaign. The dynamic floor prices assist with allowing reserved campaigns to win a desired portion of the advertising auctions so that guarantees for advertising impression delivery are satisfied. Additionally, by allowing floor prices to vary depending on the type of inventory and/or the types of reserved campaigns, floor prices can assist with allowing a representative cross-section of all advertising impressions to be assigned to reserved campaigns.

### Reserved, Non-Reserved, and Hosted Campaigns

In various embodiments, an owner of an available advertising impression (also referred to herein as a publisher) can fill the impression with a hosted advertisement as either part of a reserved campaign or as non-reserved advertising. Alternatively, the publisher can offer the impression in an auction and allow third parties to compete for the right to provide a payload to fill the impression. As one example, an impression can correspond to an available advertising location on a web page being delivered by a publisher where advertising can be displayed. Typically, the page is delivered to a person viewing the web page via a browser. In this situation, the browser represents an interface that will contain the available impression. An advertiser can provide a payload to the publisher for display in the impression location. This payload can be provided to the publisher in advance, or the payload can be delivered near the time when the impression becomes available.

A web browser represents only one option for an interface where an advertising impression can become available. Any other convenient interface that includes an advertising impression can also be served according to the invention. For example, instead of appearing in a browser, an impression could be available in another type of interface, such as on a screen displayed by a mobile phone or other computing device. The screen interface on the computing device could be a home screen, a screen displayed during startup of the computing device, a screen arrived at via a menu, or any other convenient screen displayed by the computing device. As another example, some or all of the purchase price for an application could be replaced by instead serving advertisements to the user of the application. In this type of embodiment, the application represents the interface, with the advertising impression appearing as part of the application. For an application on a processor connected to a network, the impression could be filled according to the invention when the impression becomes available, such as at launch or at various times during use of the application. Alternatively, impressions can be auctioned in advance so that advertising is included with the application. Any other convenient timing for conducting an auction and providing it to an application can also be used.

A reserved campaign refers to an order for display of advertising impressions, with some type of minimum constraint on the number of impressions that will be provided. A reserved campaign can be hosted by the publisher. The number of impressions corresponding to the minimum constraint can be referred to as a delivery guarantee. If the minimum number of impressions are not delivered, then the publisher may be required to pay a penalty to the advertiser. Typically, for a reserved campaign the advertiser can provide the payloads (advertisements for display) to the publisher in advance. When a publisher identifies an impression that matches the constraints for a reserved ad campaign, the payload corresponding to the campaign can be retrieved in response to the available impression and transmitted for display in the identified impression location. Alternatively, if an advertiser has a suitable on-line capability, the payload can be retrieved by the publisher from the on-line capability as needed and transmitted in response to the availability of an advertising impression.

A non-reserved advertising campaign can refer to an order for advertising impressions that does not include a guarantee of a minimum number of impressions. Instead, a non-reserved advertising campaign can compete for available impressions based on price. Non-reserved campaigns can also specify constraints regarding the content of the web page containing the impression, the characteristics of the user, or other constraints. A non-reserved campaign can represent a campaign hosted by a publisher. In this situation, the publisher can acquire the advertiser's materials in advance and serve or transmit the advertisements in response to when suitable impressions become available. Alternatively, a non-reserved campaign can correspond to advertising that a publisher receives by offering an impression on a spot market for advertising. This can allow any advertiser to compete for the impression based on price, regardless of whether the publisher has a prior relationship with the advertising entity.

Conventionally, a simple way to allocate advertising for reserved campaigns relative to non-reserved campaigns can be to simply allocate all advertising for reserved campaigns first. Under this conventional method, impressions can be made available to non-reserved campaigns only after all demands from reserved campaigns have been satisfied. While this method of allocation can facilitate meeting the guarantee goals of reserved campaigns, this allocation method may not provide the best match of advertising with available impressions with regard to revenue. In particular, a non-reserved campaign may be willing pay more for a high value impression than a reserved campaign. Thus, it can be desirable to balance the goal of delivering reserved advertising impressions with the goal of increasing revenue derived from each impression.

### Second Price Auctions

One option for allowing competition between various bidders for an advertising impression is to use an auction format. An auction format generally refers to a process for collecting bids from various bidders. Optionally, after receiving the bids, one or more of the bids can be modified using a weighting factor. The bids can then be compared to a floor price, as described below. If none of the optionally modified bids from a non-reserved campaign (often a third party bidder) is greater than the floor price, the bid is assigned for use either to the highest bid from a reserved or hosted campaign, or the bid is assigned for other internal use. If at least one of the optionally modified bids from a non-reserved campaign is greater than the floor price, the advertising impression is assigned to the entity providing the highest bid.

A second price auction is a particular type of auction format that can be useful in a variety of circumstances. In the case of bidding on advertising impressions for display in a browser, the auction for an impression typically needs to be conducted quickly. At most, a few seconds of time will elapse from the time where a user first requests a web page containing a location for an advertising impression to the time when the advertisement should be displayed to the user. In order to conduct the auction quickly, typically only one bid is provided by each bidder to an auction marketplace. The bids are compared by an auction marketplace that controls the auction. Based on the comparison, the auction marketplace can determine a winning bid based on a highest bidder. Alternatively, the auction marketplace can determine that none of the bids are greater than a floor price for the auction that is set by the publisher. In this case, the “winning bid” corresponds to a payload selected by the publisher, as none of the competing third party bids have met the minimum price required for sale of the impression. The advertising payload corresponding to the winner of the auction can then be transmitted, in response to the available impression, for display in the impression location.

Because each bidder provides a single bid, there is some potential that the bid from the highest bidder will be noticeably higher than the bid from the next highest bidder. This can lead to inefficient bidding processes, as a bidder may be reluctant to bid the full desired value for an impression. Alternatively, such a situation can result in the winning bidder paying more than the necessary market clearing price for an impression. For an auction where each bidder provides only a single bid, one solution is to use a second price auction. In a second price auction, when at least one bid is greater than the floor price, an advertising impression is assigned to the bidder providing the highest bid. However, the final auction price paid by the winner of the auction is based on the price of the second highest bidder. The winner of the auction may pay a final auction prices that is exactly the price from the second highest bidder. Alternatively, the price from the second highest bidder may be incremented by a predetermined amount or percentage to arrive at the final auction price. In some auctions, only one bidder will be higher than the floor price. In this situation, instead of using the second highest bid value, the final auction price can be set or determined by using the floor price as the second price. Using a second price auction allows bidders to make auction bids that reflect the true value to the bidder while still providing assurance to the winning bidder that the winning bidder will not overpay for the advertising impression.

Although a second price auction format resolves some issues associated with conducting an auction, some difficulties may still remain in allowing reserved and non-reserved campaigns, or alternatively hosted and non-hosted campaigns, to compete for advertising impressions. One concern is the potential conflict between hosted advertisers and non-hosted advertisers who are competitors. For example, one factor that can impact the value of an advertising impression to an advertiser is whether the impression represents a repeat visit by a customer. An advertiser may place a higher value on delivering an advertisement to a user on the user's first visit to a web site, with lower values for each successive visit. Based on this higher value, the advertiser may win the auction for the initial advertising impression. For subsequent impressions, however, the reduced value for the advertiser may allow a competitor to win the later auctions. Similarly, an advertiser may place different values on when and how frequently an advertisement is displayed as part of an application. These types of considerations can create a tension for a hosted advertiser that pays in advance for an advertising campaign. In order to improve the relationship between the publisher and a potential hosted advertiser, the publisher can use a floor price to mitigate the ability of a competing advertiser to win the auctions for subsequent impressions at a lower cost.

Another concern for a second price auction is retaining value in a low bid density situation. If the price difference between the winning bid and the second bid is large, a second price auction can lead to loss of revenue for a publisher. A floor price can mitigate this effect, by providing an artificial “second bid price” for an auction. If the second bid price in an auction is below the floor price, the floor price can be used in place of the second bid price.

Still another potential concern is related to allowing reserved (or guaranteed) campaigns to compete with non-reserved campaigns. Reserved campaigns often are structured to have a fixed price per impression delivered. However, the advertiser that purchases a reserved campaign will generally expect that the impressions used for the reserved campaign represent a typical cross-section of available impressions. By contrast, a non-reserved campaign will often use different bidding strategies for different types of impressions. As a result, a reserved campaign may have difficulty in winning certain types of impressions that are perceived as valuable by a non-reserved campaign bidder. In order to prevent this skimming of valuable impressions by non-reserved campaigns, the valuable impressions can be identified in advance and associated with a floor price. The associated floor price can be used to assist the reserved campaign in winning a representative portion of the valuable impressions.

### Inventory and User Segmentation

In order to understand the value of an advertising impression, and therefore set an appropriate floor price in an auction for the impression, it can be helpful to have an understanding of the value of the impression to internal or hosted bidders. Additionally, it can also be helpful to have an understanding of the value of the impression to external or third party bidders. As a starting point for gaining this understanding, advertising impressions can be summarized to allow for analysis of impressions as groups of related impressions, as opposed to having to determine an individual value for each and every impression.

One way of summarizing the value of a potential advertising impression is to develop categories of impressions. In this discussion, an inventory segment is defined as a category for advertising impressions. In some embodiments, inventory segment may also be referred to as page groups or may be related to page groups. Assigning an impression to an inventory segment provides a way to pass detailed information about a potential impression, such as external valuation and internal valuation information, in a minimum of space. Any convenient number of inventory segments can be developed for use, such as at least 10, or at least 100, or at least 1000, or at least 10,000. Having a greater number of inventory segments can allow for more granularity in differentiating various inventory types (i.e., impressions), but with an added computational cost. Preferably, an impression will be assigned to one inventory segment or less. For inventory that is not assigned to a segment, a set of default impression values can be used, which could be viewed as a default value segment.

A variety of factors can be used to assign an impression to an inventory segment, such as information about the content of the web page requesting the impression, information about the user viewing the web page, or information about the relationship of the impression location to other features on the web page. Information about the content of a web page can refer to various levels of information. At a general level, a web page could be categorized as related to sports, news, weather, politics, or another general topic. Some web pages will have more specific content that allows for placement of the web page into a narrower segment, such as sports-basketball, news-economy, or travel-Europe. Still narrower types of segments are possible, if desired. Increasing the number of available segments will increase the ability to provide independent values for various types of web page impressions, but at the cost of increased processing time for finally delivering an advertisement when a request is made by a web page.

In addition to the content of a web page, the person viewing the web page may influence the inventory segment assigned to an impression. One consideration may be the level of interaction expected from the person viewing the advertising impression. Some web page viewers, or demographic categories of web page viewers, may be known to have a high likelihood of clicking through an advertisement to visit an advertiser's web site. Other web page viewers, or other demographic categories of web page viewers, may have a history of little or no interaction with advertisements. In another situation, simply providing the impression to the web page viewer may be more important than a likelihood of interaction. Thus, one or more demographic factors of the user may be relevant to the inventory segment assignment, such as age, gender, or income level. If past web browsing behavior, past web shopping behavior, or other profile factors are available, these could also be used in making a determination of the inventory segment to assign to an impression. Still another consideration can be the geographic location of the person viewing the impression and/or a geographic location associated with the advertisement.

In addition to a click through rate and various characteristics related to the person viewing a web page, still other factors can be used to determine the inventory segment to assign to an impression. These factors can be used to represent that an impression is more valuable (or less valuable) than a typical impression. For example, a plurality of different types of sports-related web pages may have an available impression. Although the various web pages all have sports content, the corresponding impressions can have different values. One web page may have users that typically correspond to a desired advertising demographic. Another web page may correspond to a web site where past usage data (such as user surveys) indicates that users pay less attention than average to advertising on the page. Yet another web page may have an available impression, but the location of the impression on the page is known to be less favorable based on general statistics across various types of pages. Still another web page may simply be a web page that is desired by one or more advertisers, and therefore the one or more advertisers will pay more for impressions on such pages. More generally, any other type of data related to the web page content, the characteristics of the user, or the interaction of users with the type of impression can be used in determining the inventory segment to associate with an impression.

In addition to providing categories or segments for impressions, categories or segments can also be provided for users of available impressions, such as an advertiser that pays for a reserved or non-reserved hosted campaign. Categories for users, such as advertisers, are referred to herein as user segments. The segments for categorizing users can be separate from the segments for categorizing impressions. The user segments allow the characteristics of an advertiser to be described in detail in a minimum of space. The characteristics for an advertiser can include an amount the advertiser typically pays for an impression (an internal valuation), as well as information related to typical bid prices by third parties that compete with this advertiser (an external valuation). Of course, the internal valuation and external valuation information can be modified by other factors. Preferably, a user will be assigned to one user segment or less. A user that is not assigned to a user segment can be assigned to a default user segment.

A user, such as an advertiser, can be assigned to a user segment based on various factors. One factor can be the type of content associated with an impression that an advertiser will desire. This can be a general topic preference, such as sports or news, or a specific topic such as sports-basketball or news-automotive industry. Another factor can be the type of viewer desired by the advertiser. Some advertisers may be interested in impressions where a user is more likely to interact, while other advertisers may be satisfied with any type of impression. Still another factor can be the priority for winning impressions of a particular type of content. In an alternative embodiment, if a sufficient number of user groups are available, each advertiser can be assigned to a different user group.

While subject matter of interest and/or priority for winning an impression of a particular type may be factors for assigning a user to a user segment, such factors may not be sufficient to capture a special relationship between some users and some types of content. These special user-inventory relationships can be represented by interaction segments. An interaction segment is defined as a segment corresponding to one or more users and one or more inventory types. When the user selected to compete for an impression and the category of the impression both match an interaction segment, the interaction segment can be used in place of the assigned user and inventory segments. In some alternative embodiments, each interaction segment can correspond to one user segment and one inventory segment.

It is not necessary that all users in an interaction segment belong to the same user segment. Similarly, it is not necessary that all impressions associated with an interaction segment belong to the same inventory segment. Instead, an interaction segment allows a separate set of values to be used when a particular combination of user and inventory is detected. This separate set of values is different from the values that would be expected based on the respective user segment and inventory segment. A user does not have to be associated with any interaction segments, but a user can be associated with one or more interaction segments, such as 5 or less, or 25 or less, or 50 or less, or 100 or less. Similarly, an impression does not have to be associated with any interaction segments, but an impression can be associated with one or more interaction segments, such as 5 or less, or 25 or less, or 50 or less, or 100 or less. An interaction segment can include only one user-inventory pair, or multiple user-inventory pairs can belong to the same interaction segment. Alternatively, an interaction segment can include a list of one or more users and a list of one or more inventory types, with any combination of user plus inventory from the lists resulting in use of the interaction segment.

Interaction segments allow a separate set of internal and external valuations to be used for combinations of a user and an inventory type where the general valuations do not capture the proper valuation. For example, an advertiser may be generally interested in sports, but the advertiser may have a special advertising campaign intended impressions available on a sports-football web page where both a top banner impression location and an adjacent right side impression location are available at the same time. An interaction segment could define the special value placed on such impressions by the advertiser, so that a higher floor price is assigned to allow a hosted campaign to win a higher percentage of these impressions. As another example, a third party (non-hosted) advertiser may be offering high value bids for impressions on news stories related to the price of oil or fuel economy regulations. If these impressions are valuable as part of a hosted overall automotive brand awareness campaign, a higher floor price can be set to allow the automotive brand awareness campaign to win a representative portion of these impressions.

### Historical Auction Data and Future Win Rates

In addition to defining the scope for various inventory segments, user segments, and interaction segments, some method is needed to associate valuation information (and possibly other information) with the various segments. One source of information for an internal valuation of a segment can be based on a contract value for displaying hosted impressions. The contract value divided by the number of impressions guaranteed by the contract provides a rough value for cost per impression. This type of information can be used to develop an internal valuation for a user segment corresponding to an advertiser.

Information regarding contract values can also be used to generate internal valuations for inventory segments. If only one hosted campaign is interested in a particular inventory segment, the internal valuation for that segment may be directly related to the value for the hosted campaign. More typically, multiple hosted campaigns will have some interest in a given inventory segment. The values from the various campaigns can be aggregated to generate an internal valuation for the inventory segment. The internal valuation can represent an average value based on the hosted campaigns, a maximum value based on the hosted campaigns, or another value calculated based in part on the value of the inventory segment to the various advertisers.

Additional valuation information can be generated based on historical auction data. Historical auction data can be obtained from an entity that operates an auction marketplace. When an auction is conducted, an auction marketplace will typically receive bids from various sources, including at least one bid from the publisher of the impression and bids from one or more third party bidders. This bidding information can be collected and stored, along with information regarding the impression being auctioned, for later analysis of the auction. While potentially every auction conducted could be used for later analysis, due to the number of advertising impressions generated each day, it may be more convenient to work with a smaller data set. For example, an auction marketplace can randomly (or non-randomly) select about 0.1%, or about 1%, or about 10% of all auctions as sources of data for future analysis.

When an auction is selected for analysis, a variety of features from the auction can be stored. Of course, one or more features related to the advertising impression being auctioned can be stored. If the auction data is intended for use by the publisher of the advertisement, it may be sufficient to provide a reference number for the impression, as the publisher may already have more detailed information regarding the impression. Alternatively, any convenient features of the impression can be stored, such as information about the content of the web page requesting the impression, information about the user viewing the web page, information about the relationship of the impression location to other features on the web page, or other information that may be useful for determining a value of the impression.

In addition to information about the impression, a number of features related to the auction bidding can be stored. These can include, but are not limited to, an identity of the winning bidder; an identity of one or more other bidders, up to all of the bidders participating in the auction; the amount of the winning bid and the second bid; the amount of one or more additional bids, up to all of the bids provided; any bid modification information for any of the bids; and/or a reason for rejecting one or more bids. It is noted that an identity of a bidder may not necessarily provide the true identity of a bidder. Instead, a bidder identity may simply be a code or token that allows for recognition of a bidder as being the same across multiple auctions without revealing the bidder's identity.

Based on the information stored over multiple auctions, various types of information can be developed. The data can be analyzed to associate different types of impressions with different bidding patterns. Some impressions may receive a large number of bids while other impressions receive relatively few. Other impressions may be of particular interest to one or more bidders, even though an overall category for the impression would indicate a low value. In addition to the number of bidders, the winning and non-winning bid values for a type of impression as well as the distribution of bid values can be analyzed.

Based on analysis of the stored bidding information, additional valuation information can be generated for use by various segments. First, the stored bidding information can be used to generate external valuations for various inventory segments, such as by analyzing winning bids and bid structures. Additionally, by aggregating historical information about multiple content types that are of interest to a hosted advertiser, an external valuation for competitors of a given advertiser can be generated.

Based on the contract values for hosted campaigns (internal valuation), and the historical auction data for various inventory types (external valuation), floor prices can be determined in order to adjust future win rates for a hosted advertising campaign. A comparison of internal and external valuations for a given advertiser and inventory segment can be used to generate an estimate of the expected win rate for an advertiser. If this win rate will not be sufficient to meet the guaranteed impressions for a campaign, the floor price information for an inventory segment and/or a user segment can be adjusted to increase the win rate for the guaranteed campaign.

Another use of historical data is related to inventory segments with a high value or special value for a hosted advertiser. One or more third party bidders may offer increased bids for certain types of impressions, resulting in all of these high value impressions being “skimmed” from the inventory. A general increase in floor price for a user segment might be able to avoid this result. Alternatively, an interaction segment could be used to set a higher floor price for these desirable impressions. The higher floor price would increase the number of auctions that fail to achieve the floor price, thus allowing the hosted campaign to win a larger number of the high value impressions. This can allow the advertiser to not only achieve a desired win rate of impressions, but to also have the desired win rate correspond to a representative cross-section of impressions. Using an interaction segment to set this higher floor price allows a lower floor price to be used for the majority of inventory segments of interest to a given advertiser while still allowing the advertiser to “win” a representative cross-section of the auctions.

In addition to inventory segments, another option for distinguishing between bidders is to determine floor price information that includes a plurality of floor prices, such as a vector of floor price information. Instead of calculating a single floor price based on an inventory segment and a user segment, a plurality of floor prices can be calculated. The differences in the plurality of floor prices can be based at least in part on identities of bidding advertisers. The identities of the bidding advertisers for determining the plurality of floor prices may be known in advance. Alternatively, a plurality of floor prices can be calculated based on identities of a plurality of known advertisers without knowing which of the advertisers will bid in a particular auction. This could allow for setting of different floor prices for repeat bidders that are actually competitors for selling impressions.

It is noted that other mechanisms can also be used to adjust the win rate for a hosted campaign. One method for controlling the win rate for a hosted campaign is to simply expose fewer impressions to an auction marketplace, resulting in an automatic “win” for a hosted campaign. Another option for controlling the win rate is to use bid bias values. Bid bias values are weighting factors that can be used to increase or decrease a bid value prior to determining the winner of an auction. For example, bid bias values between 0 and 1.0 can be applied to various third party bidders during an auction.

### Example—Dynamic Floor Price Determination Based on Segment Information

The following is an example of how segment information could be used to assign floor prices for an auction of an impression. In this example, a person accesses a web page to view the content of the web page. The web page includes a location for an advertising impression.

The publisher of the web page uses information related to the content of the web page, the nature of the entity viewing the web page, and other factors to assign the web page to an inventory segment. Based on historical auction data, it is known that the inventory segment for this impression typically receives a high bid density. Based on the high bid density, the external valuation for this inventory segment is represented as an average external winning bid and a width of a standard deviation (or other type of distribution) for this average external winning bid value. Alternatively, if the bid density had been a low density, the external valuation could have been characterized based on the number of expected bids, along with an expected high bid and an expected low bid.

In addition to the external valuation, an internal valuation is assigned for the inventory segment. The internal valuation in this embodiment corresponds to the average value for a bid by a hosted campaign when a hosted campaign is selected to compete in an auction for this inventory segment. Alternatively, the internal valuation could be set to the average bid value by all hosted campaigns for this inventory segment.

The inventory segment is also associated with 10 interaction segments. One of these 10 interaction segments represents an interaction between the inventory segment and advertiser Bravo Business. Each of the interaction segments contains an internal and external valuation.

Either before or after assigning an inventory segment, the publisher also selects a hosted campaign that will compete for the impression in an auction. The publisher has hosted campaigns from Abel Company and Bravo Business where the advertising impression meets the criteria of the campaign. The publisher can select between Abel Company and Bravo Business in any convenient manner. The selection can be based on a random probability, such as randomly assigning impressions in accordance with the proportion of guaranteed impressions that each advertiser has purchased. Alternatively, the publisher can internally allow competition between the Abel Company and Bravo Business campaigns to earn the right to bid on the impression. At this stage of the example, Abel Company is selected to compete for the impression in the auction.

Abel Company is associated with a user segment. The user segment includes an internal valuation and an external valuation. The internal valuation corresponds to the average bid value by all advertisers in the user segment. In this example, Abel Company and Item Inc. have similar advertising strategies and use similar bids for impressions, and were therefore associated with the same user segment. In this example, the internal valuation corresponds to the average bid value across bids from both Abel Company and Item Inc. Alternatively, the internal valuation for a user segment could be based on the highest average bid value for a single advertiser within the user segment. Still another option could be to have a different user segment for each advertiser, with the internal valuation corresponding to the average bid for the advertiser for that segment.

The user segment associated with Abel Company also includes an external valuation. One possible external valuation could be the average winning bid by a third party bidder for auctions that Abel Company participates in (or that all users in the user segment participate in), along with a standard deviation. Other possible values could be used instead.

Abel Company is also associated with 10 interaction segments. These interaction segments represent inventory types that should be handled using values other than the typical internal valuation and external valuation for Abel Company. The inventory segment for the impression in this example does not match any of the interaction segments for Abel Company.

Based on the inventory segment and user segment information, the floor price can now be calculated. First, the interaction segments for both the inventory segment and for Abel Company are checked to verify that there is not an appropriate interaction segment. In some embodiments, this check can be performed by verifying whether the inventory segment and the user segment have a matching interaction segment. In this example, an interaction segment between Abel Company and the inventory segment does not exist. As a result, a floor price will be determined based on the valuations for the user segment and the inventory segment. Note that if Bravo Business was the selected advertiser, an interaction segment would be available, and the floor price information from the interaction segment would be used.

To determine a dynamic floor price “p”, first a probability function or distribution “F(p)” can be developed that determines the likelihood of an external bidder providing a bid that is greater than a given floor price. In this example, the external valuation for both the inventory segment and the user segment had the form of a winning bid value and a width of a standard distribution around this value. The external valuation for the inventory segment and the user segment can be combined in any desired manner to produce the desired probability. One option is to select the larger average winning bid value from the inventory segment and user segment values. Another option would be to use some type of average of the distributions associated with the user segment and the inventory segment. Regardless of the method, a probability function is generated that expresses the likelihood of an external bidder providing a bid that is greater than the floor price.

A value vₑₓₜ(p) is also generated that reflects the value received by the publisher if an external bidder wins the auction. As a conservative estimate, the value received when an external bidder wins the auction could be set to equal the floor price. A more detailed calculation could include expressing the received value as a variable ranging from the floor price to the maximum external bid value.

Several values related to internal bids or internal valuations can also be generated. One internal value bᵢ can correspond to the actual bid value that the hosted campaign will use for the auction. Typically, this will be related in some manner to the internal value for the user segment corresponding to the hosted campaign. Another internal bid value vₚₒₜ can reflect a potential value of the impression. As noted above, the hosted (guaranteed) campaign selected to participate in an auction may vary, and some campaigns may have higher bid values for the same type of impression. Since all guaranteed campaigns need to be satisfied, allowing an external bidder to win an impression is not just a loss of the value corresponding to the campaign participating in the auction. Instead, the opportunity cost of allowing an external bidder to win the auction should also reflect higher value campaigns that bid on the same type of inventory. This type of vₚₒₜ value is one possible choice for the internal value associated with an inventory segment.

Since two internal values are available, a balance between the values can be used to set priorities on how important each value should be in setting a floor price. This can be done using an equation like

f(bᵢ,vₚₒₜ)=[(1−w)*bᵢ]+w*vₚₒₜ

where bᵢ is the bid for the current auction, vₚₒₜ is the potential value of the impression, and w is a weighting factor. The weighting factor w can be defined as w=s^{a}, where s is the percentage of impressions in an inventory segment that are assigned or won by “high value” campaigns, and a is a parameter that can be configured to adjust the aggressiveness of keeping impressions. In other words, higher values of a will result in vₚₒₜ providing a larger component of the value of the function f(bᵢ, vₚₒₜ).

For a given auction, a floor price can be set by maximizing the equation

p*=vₑₓₜ(p)*F(p)+f(bᵢ,vₚₒₜ)*(1−F(p))

where p* is the floor price that provides the maximum value and the other variables or functions have the meaning described above.

In an optional extension, a dynamic floor price calculated based on segment information can be further modified by a random value. For example, a floor price can be calculated based on the inventory segment for an available impression and the user segment for the hosted advertiser competing in an auction. This calculated floor price can then be modified, such as by multiplying by a randomly selected value to increase or decrease the calculated floor price. The randomly selected value can increase or decrease the calculated floor price by about 5% or less, or about 10% or less, or about 20% or less. Introducing random variations in a dynamic floor price calculation can be valuable in preventing floor price discovery. If a third party bidder bids on a number of auctions, the third party bidder may be able to gain information over time about the floor prices being used in similar auctions. Even though the floor price is being calculated dynamically, such a dynamic calculation does not necessarily mean that the floor price will have large fluctuations. If a third party bidder is able to determine the floor price associated with particular types of auctions, the third party bidder may be able to use the information to modify bidding patterns in a way that reduces the benefits of having the dynamic floor price. Introducing an additional random valuation into the floor price calculation can reduce the likelihood that a third party bidder will determine accurate information regarding floor price.

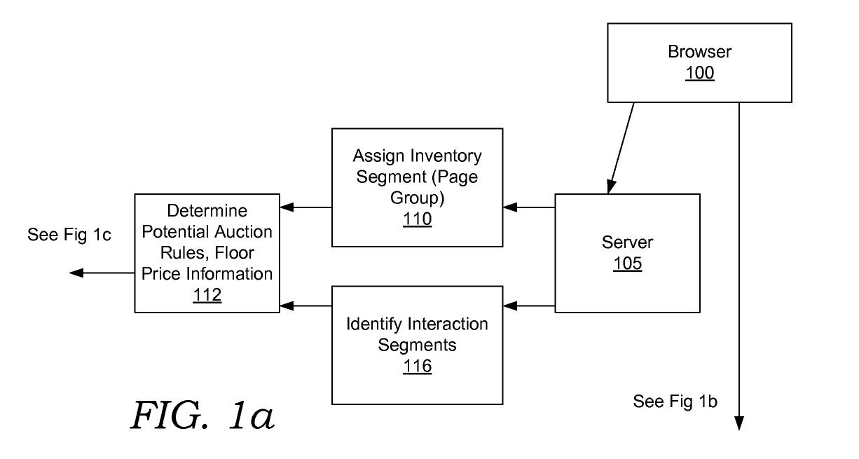

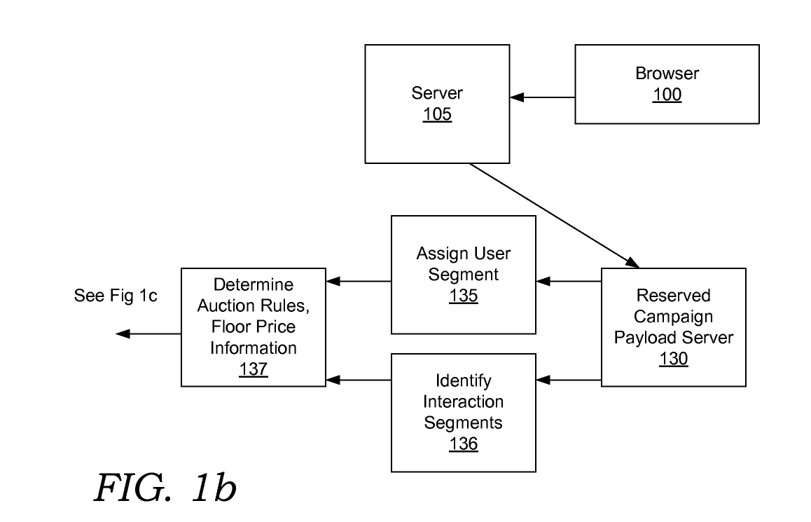

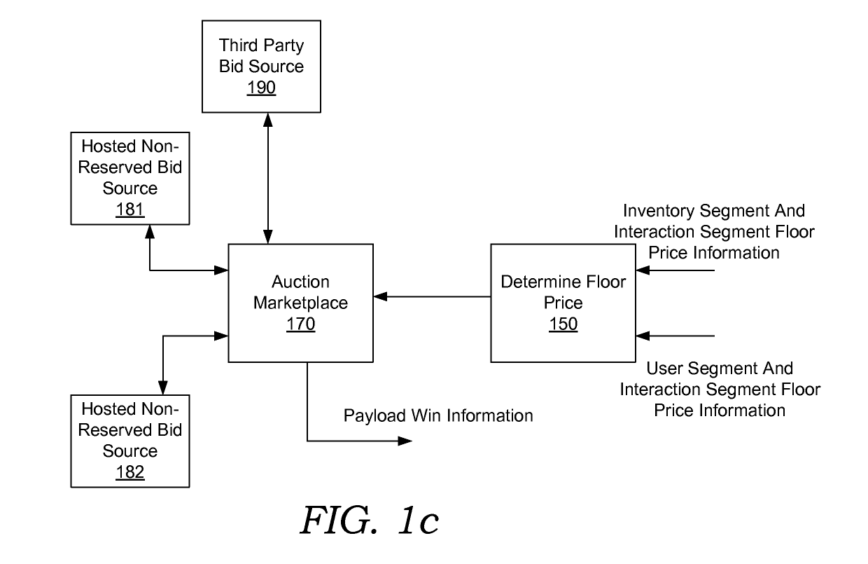

FIG. 1a schematically shows the initial steps for assigning a floor price to an available impression based on the type or inventory segment of available ad impression. FIG. 1b schematically shows the initial steps for assigning a hosted or reserved advertisement payload and a floor price based on the types of reserved campaigns that are suitable for appearing in the impression location. In FIG. 1c, the outputs from the initial steps in FIGS. 1a and 1b can be used to conduct an auction for the available impression that includes bids from non-guaranteed campaigns.

In FIG. 1a, a browser 100 displays a web page to a user. The web page can include a location for an advertising impression. The browser can send an ad request to a server 105 to obtain an advertising payload for display in the impression location. The ad request is forwarded by server 105 to the payload server for reserved campaigns. This will be discussed further in FIG. 1b. The ad request is also evaluated by server 105 to determine information related to auction rules for the ad request, including at least floor price information, such as by assigning an inventory segment (or page group) 110 for the ad request. Alternatively, server 105 can forward the ad request to another server that assigns the inventory segment 110. Each impression can have an associated inventory segment 110. The ad request is also further evaluated by server 105 (or another server) to identify any potential interaction segments 116 that are appropriate for the impression. Based on the inventory segment 110 and interaction segment(s) 116, potential auction rule sets for the auction can be determined 112, including information for setting a floor price. The potential auction rules can also provide bid bias information. A bid bias can represent a weighting factor applied to one or more bids competing for an impression. The bid bias weighting factor can give preference to some types of bids to win a particular impression. For example, a bid bias can be applied to all ads that are not part of a reserved campaign. This can reflect a desire to meet the requirements of guaranteed campaigns first unless a non-guaranteed advertisement can pay a sufficient premium to the publisher.

In FIG. 1b, the server 105 forwards an ad request to the payload server 130 for guaranteed campaigns. The payload server 130 can analyze the nature of the ad request. Suitable payloads can be identified, and the bid associated with each payload can be evaluated. The determination of how a given reserved payload will bid for an impression can be determined ahead of time. For example, this can be determined based on the expected allocation of impression to reserved campaigns. Based on the bids, a payload from a reserved campaign can be selected to compete in an auction for the impression. After selecting a payload, a user segment corresponding to the advertiser providing the payload is assigned 135. Interaction segments corresponding to the advertiser can also be identified 136. The user segment and interaction segment(s) can be used to determine 137 potential auction rule set information, including at least floor price information, as well as potential bid biases and other information associated with the payload. The potential auction rule set information, floor price information, bid biases, and optionally other information can then be forwarded for further processing.

In FIG. 1c, the floor price information based on the inventory segment, user segment, and interaction segments can be used to determine a floor price 150 for the auction. First, the interaction segments are checked to determine if an interaction segment matches the combination of the impression and the competing hosted payload. If a matching interaction segment is identified, the floor price information from the interaction segment is used to determine the floor price. If not, the floor price information from the inventory segment and the user segment are used to determine the floor price. At this point, if other auction rule set information is available, an auction rule set for the auction can be selected. Similarly, if bid bias information, or any other information is available, this additional information can be used to determine how the auction will be conducted. After determining 150 the floor price, the ad request, the reserved campaign payload information, and the floor price can be forwarded to an auction marketplace 170. If any other information is available, such as auction rules or bid bias values, such information can also be forwarded to an auction marketplace 170. The auction marketplace 170 can then accept bids from other advertising sources. The bids can come from other non-guaranteed ad campaigns being hosted by the same publisher, or the bids can come from third party publishers. In FIG. 1c, two separate streams 181 and 182 of non-guaranteed ad campaigns hosted by the publisher/owner of the marketplace are shown, along with a representation 190 for bids from third party ad publishers.

The auction marketplace 170 can accept bids from various bidders. If bid bias values are available, the bids can be weighted based on the corresponding bid bias values. Based on the bid values, as modified by optional bid bias values, a winning bid can be determined. The winning bid can also be compared to the floor price. If the winning bid is lower than the floor price, the auction marketplace 170 can return that information, and the selected hosted campaign advertisement can be served to the browser for delivery in the impression location. If the winning bid (optionally adjusted by bid bias values) is greater than the floor price, the payload corresponding to the winning bid can be served back to the browser for delivery in the impression location.

### EXAMPLES

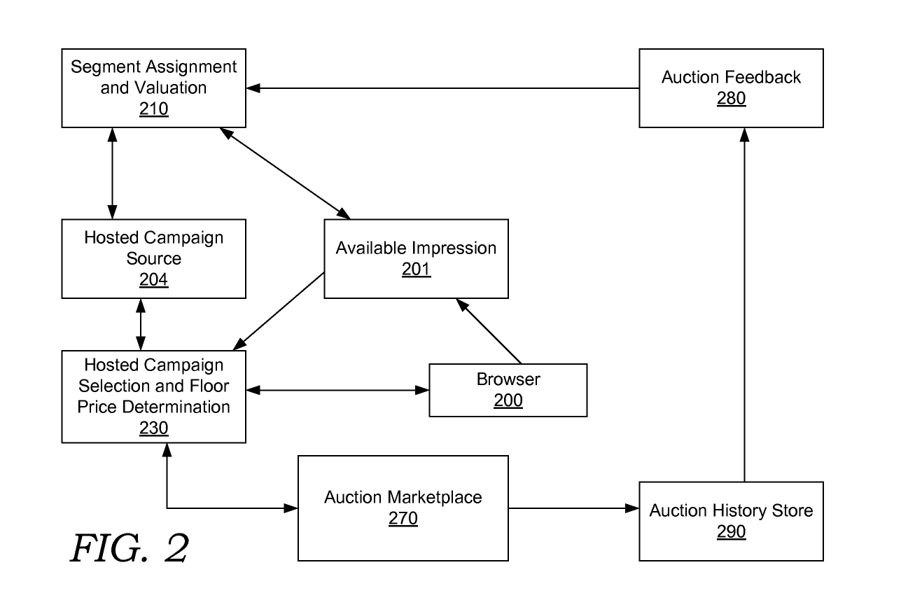

FIG. 2 provides an overview of another process flow according to an embodiment of the invention. The various actions shown in FIG. 2 can be performed on one or more computers connected by one or more computer networks, such as the Internet, an intranet, private and public local networks, and wireless data or telephone networks. In FIG. 2, hosted campaign source 204 corresponds to orders hosted by a publisher, which may have minimum impression delivery guarantees. The hosted campaign source 204 contains the details of any hosted campaigns, such as the constraints for types of impressions desired by the campaigns and baseline bid values. The information regarding hosted campaigns in source 204 can be used by segment assignment and valuation module 210 to assign user segments to the various hosted campaigns. Optionally, segment assignment and valuation module 210 can also identify one or more interaction segments that are associated with hosted campaigns. Segment assignment and valuation module 210 can also assign inventory segments to available impressions 201 when an advertising display request is received from a browser 200. In addition to assigning segments, segment assignment and valuation module 210 can also determine valuations to associate with various segments. The valuation for a segment can be updated on a periodic basis based on feedback from auctions that is received from auction feedback module 280.

When an advertising request with an available impression 201 is received from a browser 200, an inventory segment is assigned to the available impression 201 by segment assignment and valuation module 210. Optionally, segment assignment and valuation module 210 can also identify one or more interaction segments for the available impression. The available impression 201 and corresponding segment information is passed to hosted campaign selection and floor price determination module 230. The module 230 then selects an advertisement from a hosted campaign in hosted campaign source 204 that is suitable for the available impression 201. The selected advertisement also has corresponding segment information. The segment information for both available impression 201 and the selected advertisement is used to determine a floor price for an auction.

The available impression, the selected advertisement, and the floor price information are then forwarded to auction marketplace 270. The auction marketplace conducts an auction and determines a winner based on received bids and the floor price information. The winning bid and payload information is returned to hosted campaign selection and floor price determination module 230 for communication to the browser that initiated the advertising request. If the auction is selected for use in providing feedback, information regarding the auction is also passed to auction history store 290. The auction history store provides raw data for auction feedback module 280 to use in determining various types of historical auction information, such as distributions of bid values for auctions on a particular inventory segment.

Having briefly described an overview of embodiments of the present invention and some of the features therein, an exemplary operating environment suitable for implementing the present invention is described below.

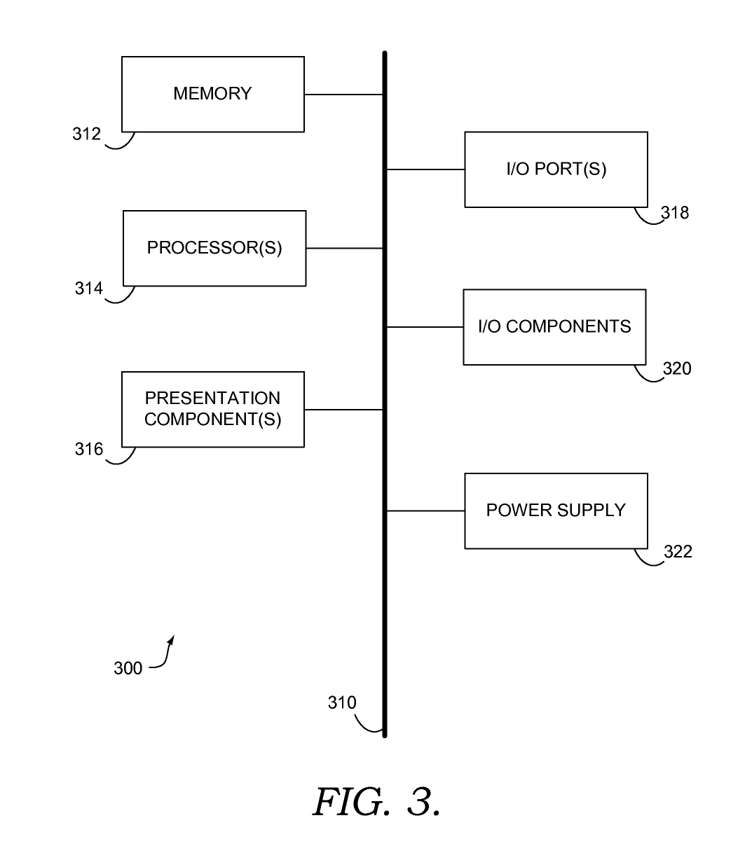

Referring to the drawings in general, and initially to FIG. 3 in particular, an exemplary operating environment for implementing embodiments of the present invention is shown and designated generally as computing device 300. Computing device 300 is but one example of a suitable computing environment and is not intended to suggest any limitation as to the scope of use or functionality of the invention. Neither should the computing device 300 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks or implements particular abstract data types. Embodiments of the present invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 3, computing device 300 includes a bus 310 that directly or indirectly couples the following devices: memory 312, one or more processors 314, one or more presentation components 316, input/output (I/O) ports 318, I/O components 320, and an illustrative power supply 322. Bus 310 represents what may be one or more busses (such as an address bus, data bus, or combination thereof). Although the various blocks of FIG. 3 are shown with lines for the sake of clarity, in reality, delineating various components is not so clear and, metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 3 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 3 and reference to “computer” or “computing device.”

The computing device 300 typically includes a variety of computer-readable media. Computer-readable media can be any available media that can be accessed by computing device 300 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, or any other medium that can be used to encode desired information and which can be accessed by the computing device 300. In an embodiment, the computer storage media can be selected from tangible computer storage media. In another embodiment, the computer storage media can be selected from non-transitory computer storage media.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Memory 312 includes computer-storage media in the form of volatile and/or nonvolatile memory. The memory may be removable, nonremovable, or a combination thereof. Exemplary hardware devices include solid-state memory, hard drives, optical-disc drives, etc. Computing device 300 includes one or more processors that read data from various entities such as memory 312 or I/O components 320. Presentation component(s) 316 present data indications to a user or other device. Exemplary presentation components include a display device, speaker, printing component, vibrating component, etc. I/O ports 318 allow computing device 300 to be logically coupled to other devices including I/O components 320, some of which may be built in. Illustrative components include a microphone, joystick, game pad, satellite dish, scanner, printer, wireless device, etc.

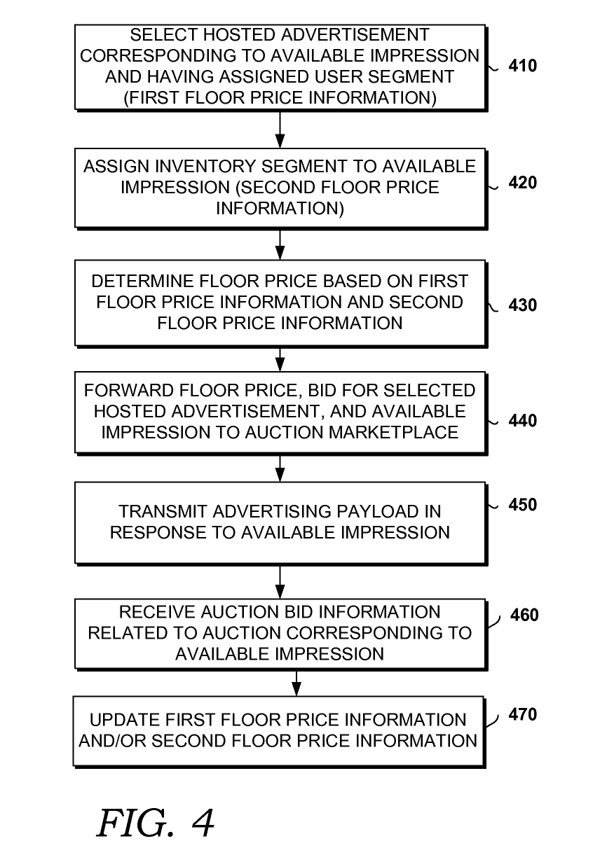

FIGS. 4-6 provide examples of additional embodiments according to the invention. In an embodiment shown in FIG. 4 for matching an available impression to an advertising payload, a hosted advertisement is selected 410. The hosted advertisement corresponds to an available impression, such as an available impression indicated by an advertising request received from a browser via an internet service provider. The selected hosted advertisement has an assigned user segment. Based on the assigned user segment, the selected hosted advertisement is associated with first floor price information. An inventory segment is assigned 420 to the available impression. Based on the assigned inventory segment, the available impression is associated with second floor price information. A floor price is then determined 430 based on the first floor price information and the second floor price information. The floor price, bid information for the selected hosted advertisement, and information related to the available impression are forwarded 440 to an auction marketplace. The auction marketplace can also be operated by the publisher, or the auction marketplace can be operated by a third party. After an auction is conducted in the auction marketplace, a winning bid is identified. An advertising payload corresponding to the winning bid is transmitted 450 in response to the available impression. The winning bid can be based on a highest bid value in the auction, or the winning bid can correspond to the floor price if none of the bids have a high enough bid value. In this latter situation, the selected hosted advertisement corresponds to the winning bid. After the auction corresponding to the available impression, auction bid information related to the auction is received 460. The received auction bid information is used to update 470 at least one of the first floor price information or the second floor price information.

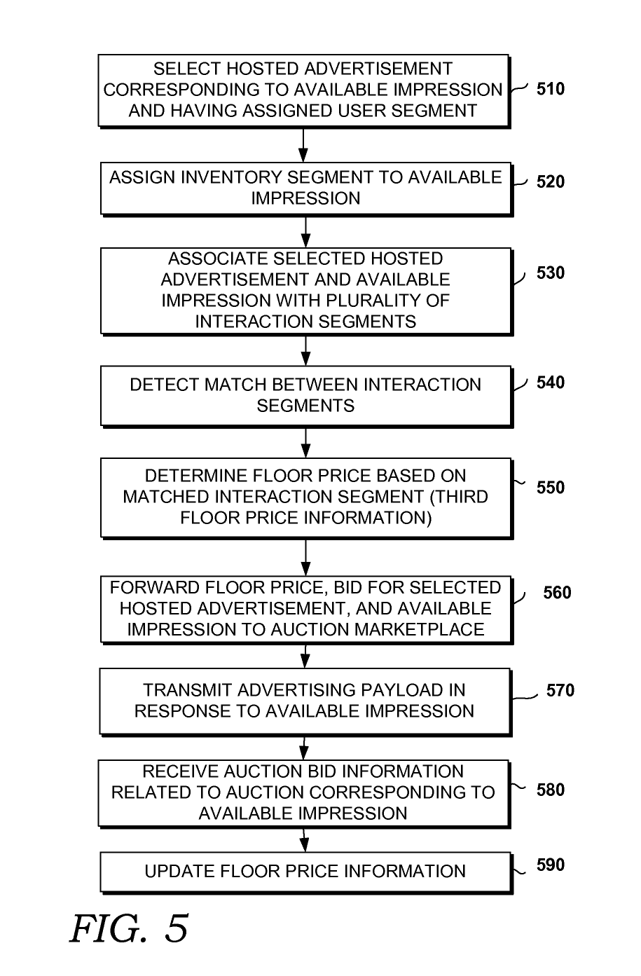

In an embodiment shown in FIG. 5 for matching an available impression to an advertising payload, a hosted advertisement is selected 510 that corresponds to an available impression. An inventory segment is also assigned 520 to the available impression. Additionally, the selected hosted advertisement and the available impression are associated 530 with a plurality of interaction segments. A match is detected 540 between an interaction segment associated with the selected hosted advertisement and an interaction segment associated with the available impression. A floor price is then determined 550 based on floor price information associated with the matched interaction segment. The floor price, bid information for the selected hosted advertisement, and information related to the available impression are forwarded 560 to an auction marketplace. After an auction is conducted in the auction marketplace, a winning bid is identified. An advertising payload corresponding to the winning bid is transmitted 570 in response to the available impression. After the auction corresponding to the available impression, auction bid information related to the auction is received 580. The received auction bid information is used to update 590 at least one of first floor price information corresponding to the assigned user segment, second floor price information corresponding to the assigned inventory segment, or third floor price information associated with the interaction segment.

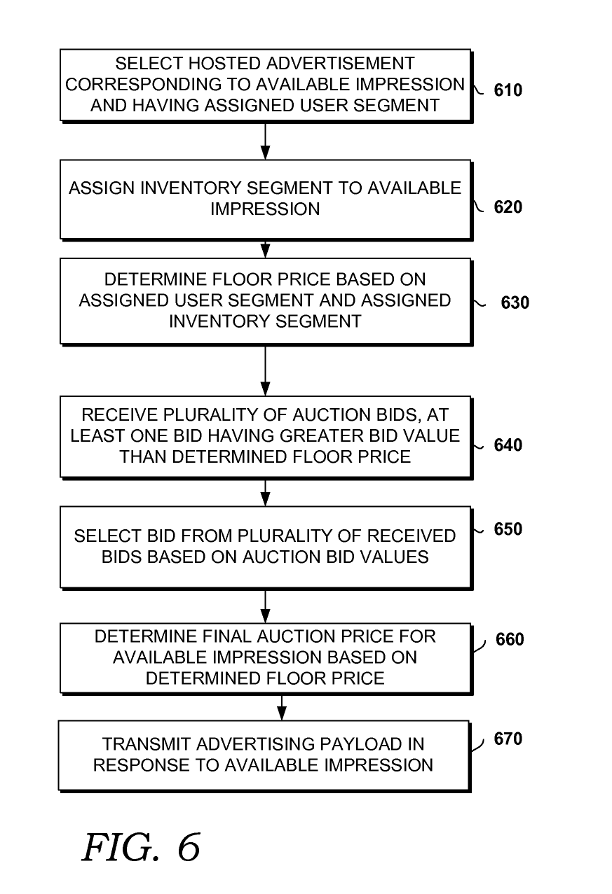

In an embodiment shown in FIG. 6 for matching an available impression to an advertising payload, a hosted advertisement is selected 610 that corresponds to an available impression. The selected hosted advertisement has an assigned user segment. An inventory segment is assigned 620 to the available impression. A floor price is then determined 630 based on the assigned user segment and the assigned inventory segment. A plurality of auction bids are received 640 for an auction corresponding to the available impression. At least one of the auction bids has a bid value greater than the determined floor price. A bid is selected 650 is selected from the plurality of received auction bids based on the auction bid values. A final auction price is determined 660 for the available impression based on the determined floor price. An advertising payload corresponding to the winning bid is then transmitted 670 in response to the available impression.

### Additional Embodiments

In an embodiment, a computer-implemented method for matching an advertising payload with an available impression is provided, comprising: selecting a hosted advertisement that corresponds to an available impression, the hosted advertisement having an assigned user segment, the assigned user segment being associated with first floor price information; assigning an inventory segment to the available impression, the assigned inventory segment being associated with second floor price information; determining a floor price based on the first floor price information and the second floor price information; forwarding information related to the available impression, bid information for the selected hosted advertisement, and the determined floor price to an auction marketplace; transmitting an advertising payload in response to the available impression, the advertising payload corresponding to at least one of the selected hosted advertisement or a payload associated with a winning bid from an auction corresponding to the available impression; receiving auction bid information, from the auction marketplace, related to the auction corresponding to the available impression; and updating at least one of the first floor price information or the second floor price information based on the received auction bid information

In another embodiment, a method for matching an advertising payload with an available impression is provided, comprising: selecting a hosted advertisement that corresponds to an available impression, the hosted advertisement having an assigned user segment, the assigned user segment being associated with first floor price information; assigning an inventory segment to the available impression, the assigned inventory segment being associated with second floor price information; associating the selected hosted advertisement and the available impression with a plurality of interaction segments; detecting a match between an interaction segment associated with the hosted advertisement and an interaction segment associated with the available impression, the matching interaction segment being associated with third floor price information; determining a floor price based on the third floor price information; forwarding information related to the available impression, bid information for the selected hosted advertisement, and the determined floor price to an auction marketplace; transmitting an advertising payload in response to the available impression, the advertising payload corresponding to at least one of the selected hosted advertisement or a payload associated with a winning bid from an auction corresponding to the available impression; receiving auction bid information, from the auction marketplace, related to the auction corresponding to the available impression; and updating at least one of the first floor price information, the second floor price information, or the third floor price information based on the received auction bid information

In still another embodiment, a computer-implemented method for matching an advertising payload with an available impression is provided, comprising: selecting a hosted advertisement that corresponds to an available impression, the hosted advertisement having an assigned user segment; assigning an inventory segment to the available impression; determining a floor price based on the assigned user segment and the assigned inventory segment; receiving a plurality of auction bids, the auction bids comprising auction bid values, at least one of the bids having a bid value greater than the determined floor price; selecting a bid from the plurality of received auction bids based on the auction bid values; determining a final auction price for the available impression based on the determined floor price; and transmitting an advertising payload corresponding to the selected bid in response to the available impression.

Embodiments of the present invention have been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure. It will be understood that certain features and subcombinations are of utility and may be employed without reference to other features and subcombinations. This is contemplated by and is within the scope of the claims.

What is claimed is:

1. A computer-implemented method for matching an advertising payload with an available impression, comprising:
selecting a hosted advertisement that corresponds to an available impression, the hosted advertisement having an assigned user segment, the assigned user segment being associated with first floor price information;
assigning an inventory segment to the available impression, the assigned inventory segment being associated with second floor price information;
determining a floor price based on the first floor price information and the second floor price information;
forwarding information related to the available impression, bid information for the selected hosted advertisement, and the determined floor price to an auction marketplace;
transmitting an advertising payload in response to the available impression, the advertising payload corresponding to at least one of the selected hosted advertisement or a payload associated with a winning bid from an auction corresponding to the available impression;
receiving auction bid information, from the auction marketplace, related to the auction corresponding to the available impression; and
updating at least one of the first floor price information or the second floor price information based on the received auction bid information.

2. The computer-implemented method of claim 1, further comprising
receiving, by the auction marketplace, a plurality of auction bids, the auction bids comprising auction bid values, at least one of the bids corresponding to the selected hosted advertisement; and
selecting a bid based on the received auction bid values and the determined floor price.

3. The computer-implemented method of claim 2, further comprising:
generating biased auction bids from the received auction bids by applying one or more bid bias values to an auction bid value for at least one received auction bid,
wherein selecting a bid based on the received auction bid values comprises selecting a bid based on at least one generated biased auction bid value.

4. The computer-implemented method of claim 2, wherein selecting a bid based on the received auction bid values comprises:
determining that the floor price is greater than the received auction bid values; and
selecting the bid corresponding to the selected hosted advertisement.

5. The computer-implemented method of claim 1, wherein the received auction bid information corresponding to the auction for the available impression comprises a bid structure, the bid structure including a winning bid value, an identity of a party that submitted the winning bid, and at least one additional bid value.

6. The computer-implemented method of claim 1, wherein updating at least one of the first floor price information or the second floor price information comprises:
determining an inventory segment corresponding to the received auction bid information;
aggregating the received auction bid information with additional auction bid information corresponding to the determined inventory segment;
calculating a distribution of winning bid values based on the aggregated auction bid information; and
updating the second floor price information based on the calculated distribution of winning bid values.

7. The computer-implemented method of claim 1, wherein determining a floor price based on the first floor price information and the second floor price information comprises:
determining a bid value for the selected hosted advertisement based on the first floor price information;
determining a potential value for the available impression based on the second floor price information;
calculating a weighted average of the determined bid value and the determined potential value;
identifying a probability function corresponding to a probability that a received bid value will be greater than a floor price; and
selecting a floor price that maximizes an expected value of the available impression, the expected value of the available impression being based on the identified probability function and the calculated weighted average.

8. The computer-implemented method of claim 1, wherein determining a floor price comprises determining a plurality of floor price values, the plurality of floor price values being based at least in part on identity of one or more parties submitting bids to the auction marketplace.

9. One or more computer-storage media storing computer-useable instructions that, when executed by a computing device, perform a method for matching an advertising payload with an available impression, comprising:
selecting a hosted advertisement that corresponds to an available impression, the hosted advertisement having an assigned user segment, the assigned user segment being associated with first floor price information;
assigning an inventory segment to the available impression, the assigned inventory segment being associated with second floor price information;
associating the selected hosted advertisement and the available impression with a plurality of interaction segments;
detecting a match between an interaction segment associated with the hosted advertisement and an interaction segment associated with the available impression, the matching interaction segment being associated with third floor price information;
determining a floor price based on the third floor price information;
forwarding information related to the available impression, bid information for the selected hosted advertisement, and the determined floor price to an auction marketplace;
transmitting an advertising payload in response to the available impression, the advertising payload corresponding to at least one of the selected hosted advertisement or a payload associated with a winning bid from an auction corresponding to the available impression;
receiving auction bid information, from the auction marketplace, related to the auction corresponding to the available impression; and
updating at least one of the first floor price information, the second floor price information, or the third floor price information based on the received auction bid information.

10. The computer-storage media of claim 9, wherein the advertising payload is transmitted to an interface containing the available impression, comprising a web page for display in a browser, an application, or a screen for display on a computing device.

11. The computer-storage media of claim 10, the method further comprising:
generating biased auction bids from the received auction bids by applying one or more bid bias values to auction bid values for at least one received auction bid,
wherein selecting a bid based on the received auction bid values comprises selecting a bid based on at least one generated biased auction bid value.

12. The computer-storage media of claim 9, wherein selecting a bid based on the received auction bid values comprises:
determining that the floor price is greater than the received auction bid values; and
selecting the bid corresponding to the selected hosted advertisement.

13. The computer-storage media of claim 9, wherein updating at least one of the first floor price information or the second floor price information comprises:
determining an interaction segment corresponding to the received auction bid information;
aggregating the received auction bid information with additional auction bid information corresponding to the determined interaction segment;
calculating a distribution of winning bid values based on the aggregated auction bid information; and
updating the third floor price information based on the calculated distribution of winning bid values.

14. The computer-implemented method of claim 9, wherein determining a floor price based on the third floor price information comprises:
determining a bid value for the selected hosted advertisement based on the third floor price information;
identifying a probability function corresponding to a probability that a received bid value will be greater than a floor price; and
selecting a floor price that maximizes an expected value of the available impression, the expected value of the available impression being based on the identified probability function and the determined bid value.

15. A computer-implemented method for matching an advertising payload with an available impression, comprising:
selecting a hosted advertisement that corresponds to an available impression, the hosted advertisement having an assigned user segment;
assigning an inventory segment to the available impression;
determining a floor price based on the assigned user segment and the assigned inventory segment;
receiving a plurality of auction bids, the auction bids comprising auction bid values, at least one of the bids having a bid value greater than the determined floor price;
selecting a bid from the plurality of received auction bids based on the auction bid values;
determining a final auction price for the available impression based on the determined floor price; and
transmitting an advertising payload corresponding to the selected bid in response to the available impression.

16. The computer-implemented method of claim 15, further comprising
receiving auction bid information from the auction marketplace; and
updating information associated with at least one of the assigned inventory segment or the assigned user segment based on the received auction bid information.

17. The computer-implemented method of claim 15, further comprising associating the hosted advertisement and the available impression with a plurality of interaction segments, wherein determining a floor price based on the assigned user segment and the assigned inventory segment comprises:
detecting a match between an interaction segment associated with the assigned inventory segment and an interaction segment associated with the assigned user segment; and
determining a floor price based on the matched interaction segment.

18. The computer-implemented method of claim 15, wherein the determined final auction price is equal to the determined floor price.

19. The computer-implemented method of claim 15, wherein the bid selected from the plurality of received auction bids is the only auction bid with an auction bid value greater than the floor price.

20. The computer-implemented method of claim 15, further comprising:
generating biased auction bids from the received auction bids by applying one or more bid bias values to auction bid values for at least one received auction bid,
wherein the bid selected from the plurality of received auction bids is the only auction bid with a biased auction bid value greater than the floor price.
